(19) United States
(12) Patent Application Publication
(10) Pub. No.: US 2013/0249860 A1
(43) Pub. Date: Sep. 26, 2013

(54) PRESSURE-SENSING TYPE TOUCH PANEL

(71) Applicant: SAMSUNG ELECTRONICS CO., LTD., Gyeonggi-do (KR)

(72) Inventors: Ho-Seong SEO, Gyeonggi-do (KR); Shi-Yun CHO, Gyeonggi-do (KR); Seok-Myong KANG, Gyeonggi-do (KR); Kyung-Wan PARK, Gyeonggi-do (KR); Ji-Hyun JUNG, Gyeonggi-do (KR); Youn-Ho CHOI, Seoul (KR)

(73) Assignee: Samsung Electronics Co., Ltd., Gyeonggi-do (KR)

(21) Appl. No.: 13/848,321

(22) Filed: Mar. 21, 2013

(30) Foreign Application Priority Data
Mar. 22, 2012 (KR) 10-2012-0029574

(51) Int. Cl. G06F 3/045

(52) U.S. Cl. CPC G06F 3/045
USPC 345/174; 338/47

(57) ABSTRACT

Disclosed is a pressure-sensing type touch panel including a plurality of sheets laminated to have a one-sheet structure, the touch panel being bonded to a rear surface of a flexible display. The pressure-sensing type touch panel has flexibility and stably recognizes the touch of an object even when incurring such deformations as bending, rolling or folding.

### PRIORITY

This application claims priority under 35 U.S.C. §119(a) to a Korean Patent Application filed in the Korean Industrial Property Office on Mar. 22, 2012 and assigned Serial No. 10-2012-0029574, the contents of which are incorporated herein by reference.

### BACKGROUND OF THE INVENTION

1. Field of the Invention

The present invention relates generally to a pressure-sensing type touch panel, and more particularly to a pressure-sensing type touch panel adapted to be flexible and to stably recognize the touch of an object even when deformed.

2. Description of the Related Art

Portable terminals have evolved into multimedia devices capable of providing various functions including, but not limited to transmission/reception, electronic organizer, game, and schedule management functions. Accordingly, portable terminals are connected with various external devices to expand their functionality to such activities as music listening, movie watching, and photography.

Input devices for portable terminals include key buttons, a mouse, and a digitizer. However, portable terminals having touch panels have increased in use, which enables various types of inputs simply by touch of an object. Particularly, significant attention has been given to flexible portable terminals, which have evolved from portable terminals equipped with touch panels.

Conventional technology related to touch panels is disclosed in Korean Registered Patent No. 10-0347439, issued Jul. 23, 2002, entitled “Touch Panel Pressure Sensing Structure and Sensing Method”, the contents of which are incorporated herein by reference.

FIGS. 1-3 illustrate schematic structures of conventional touch panels. Referring to FIGS. 1-3, the touch panels 10, 20, 30 have a plurality of sheets stacked on one another. Specifically, the touch panels 10, 20, 30 have upper panels 11, 21, 31 and lower panels 12, 22, 32, which have electrodes intersecting with each other, and a gap is formed between the upper panels 11, 21, 31 and the lower panels 12, 22, 32. Particularly, gaps 13, 23, 33 (such as air gaps or liquid gaps) are defined between the upper panels 11, 21, 31, which have a single sheet or a plurality of sheets stacked on one another, and the lower panels 12, 22, 32, which have a single sheet or a plurality of sheets stacked on one another, so that the electrodes of the upper and lower panels can contact each other by means of pressure caused by touch of an object.

The touch panel 10 shown in FIG. 1 includes an upper panel 11, which has conductive members extending in a first direction on both ends, and a lower panel 12 having conductive members extending in a second direction, which intersects with the first direction, on both ends. The upper and lower panels 11 and 12 are arranged to face each other with an air or a liquid gap 13 at the center. The touch panel 20 shown in FIG. 2 includes an upper panel 21, which has conductive members formed in the transverse direction (based on FIG. 2), and a lower panel 22, which has conductive members formed in the longitudinal direction (based on FIG. 2). The upper and lower panels 21 and 22 are arranged to face each other with an air or a liquid gap 23 at the center.

The touch panel 30 shown in FIG. 3 includes an upper panel 31, which includes a substrate 31 a having conductive members formed in a first direction and a conductive layer 31b, and a lower panel 32 including a substrate 32a having conductive members formed in a second direction, which intersect with the first direction, and a conductive layer 32b. The upper and lower panels 31 and 32 are arranged to face each other with an air or a liquid gap 33 at the center. The touch panels 10, 20, 30 of the above-described structures can recognize pressure, which is generated by touch of an object, based on a current change caused by contact resistance. Specifically, the touch panels 10, 20, 30 scan a current change between electrodes of the upper panels 11, 21, 31 and electrodes of the lower panels 12, 22, 32, which are adjacent to the place of transfer of pressure caused by touch of an object, and process the scan result to calculate the touch point.

When the touch panels 10, 20, 30 are adapted to be flexible, they undergo various types of deformation, depending on the environment, such as folding, bending or rolling. The existence of air or liquid gaps 13, 23, 33 between the upper panels 11, 21, 31 and the lower panels 12, 22, 32 generates a clearance between the stacked sheets.

FIG. 4 illustrates bending of upper panels 11, 21, 31 and lower panels 12, 22, 32, which are stacked on each other with air or liquid gaps 13, 23, 33 at the center. Referring to FIG. 4, deformation of the touch panels 10, 20, 30 changes the radius of curvature of the upper panels 11, 21, 31 and the lower panels 12, 22, 32. That is, deformation of the touch panels 10, 20, 30 changes the location at which the upper panels 11, 21, 31 and the lower panels 12, 22, 32 face each other.

The deformation also changes the distance between the upper panels 11, 21, 31 and the lower panels 12, 22, 32, i.e. gap thickness. This reveals a problem of state-of-the-art touch panels 10, 20, 30, which is the air or the liquid gaps 13, 23, 33 maintain a constant thickness before the touch panels 10, 20, 30 are deformed, but have great difficulty maintaining a constant thickness (i.e. the distance between the upper panels 11, 21, 31 and the lower panels 12, 22, 32 cannot be maintained) after the touch panels 10, 20, 30 are deformed.

Specifically, conventional touch panels 10, 20, 30 have a structural problem in that, when deformation increases the distance between parts of the upper panels 11, 21, 31 and the lower panels 12, 22, 32, recognition of touch of an object on the parts may be too weak or even fail. Furthermore, when deformation decreases the distance between parts of the upper panels 11, 21, 31 and the lower panels 12, 22, 32, erroneous recognition may be made even if there is no touch.

Therefore, there is a need for a pressure-sensing type touch panel adapted to have flexibility and to stably recognize the touch of an object even when deformed.

### SUMMARY OF THE INVENTION

Accordingly, the present invention has been made to solve the above-stated problems occurring in the prior art, and an aspect of the present invention provides a pressure-sensing type touch panel including a plurality of sheets laminated to have a one-sheet structure, the touch panel being bonded to a rear surface of a flexible display.

In accordance with an aspect of the present invention, there is provided a pressure-sensing type touch panel including a pressure-sensing layer adapted to change in response to pressure, and sheets having conductive layers and electrode layers, respectively, the sheets being laminated to both surfaces of the pressure-sensing layer, respectively, to have a one-sheet structure, wherein the conductive layers and the electrode layers are adapted to change, in response to touch of an object, and cause the realization of a haptic feel.

### BRIEF DESCRIPTION OF THE DRAWINGS

The above and other aspects, features and advantages of the present invention will be more apparent from the following detailed description taken in conjunction with the accompanying drawings, in which:

FIGS. 1-3 illustrate structures of conventional touch panels;

FIG. 4 illustrates bending of touch panels having structures illustrated in FIGS. 1-3;

FIG. 5 illustrates a schematic structure of a pressure-sensing type touch panel according to the present invention;

FIG. 6 illustrates the pressure-sensing type touch panel shown in FIG. 5 after lamination;

FIG. 7 is a schematic top view of the pressure-sensing type touch panel shown in FIG. 6, and illustrates components at different sizes laminated on one another, ranging from the first substrate panel to the second substrate panel;

FIG. 8 illustrates local deformation of the pressure-sensing type touch panel shown in FIG. 6; and

FIG. 9 illustrates a pressure value when a pressure is applied to a local portion on a laminate structure of the touch panel which is locally deformed in FIG. 8.

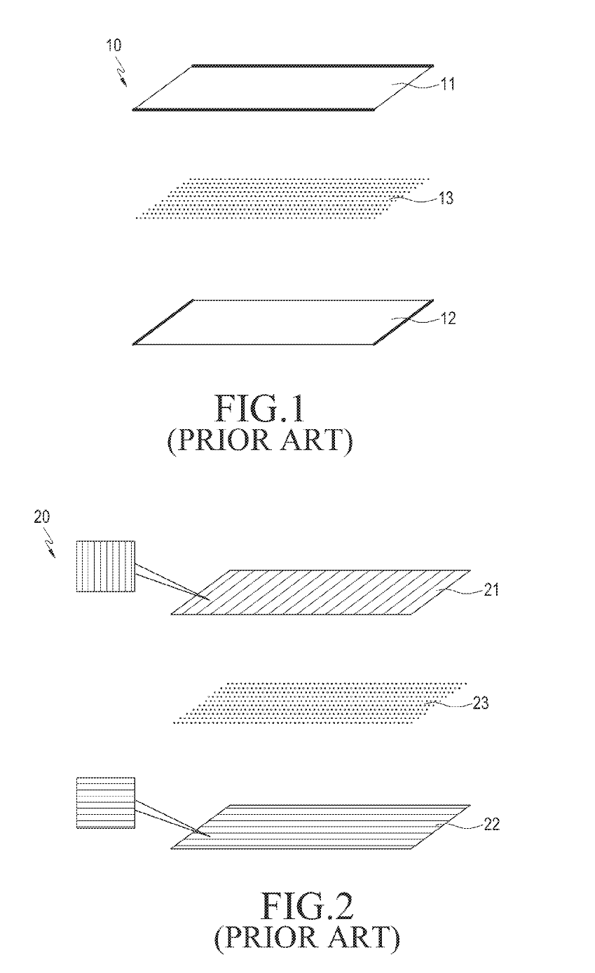

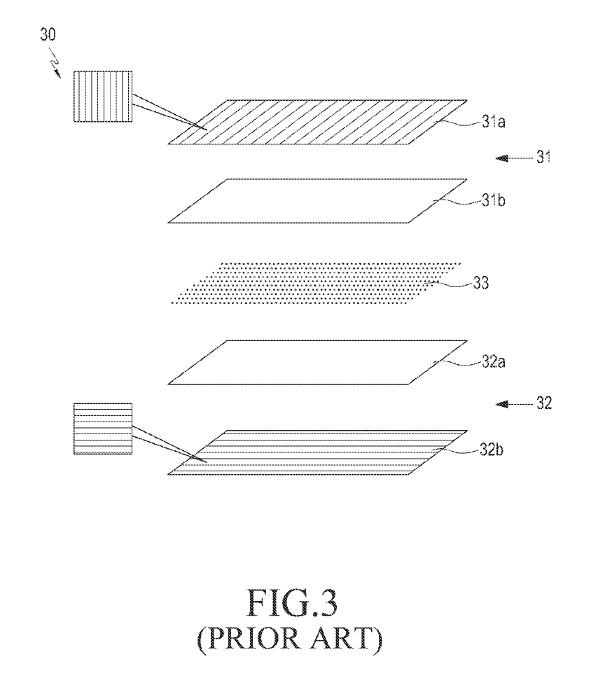

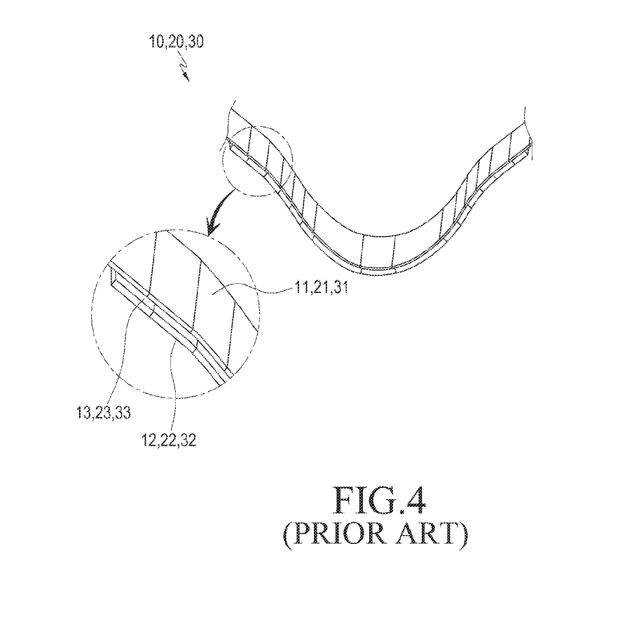

### DETAILED DESCRIPTION OF THE EMBODIMENTS OF THE INVENTION

Hereinafter, embodiments of the present invention will be described with reference to the accompanying drawings in detail. Various specific definitions found in the following description are provided only to help general understanding of the present invention, and it will be understood by those skilled in the art that various changes and modifications can be made thereto within the technical spirit and scope of the present invention. In the following description, a detailed explanation of known related functions and constitutions may be omitted for the sake of clarity and conciseness.

It is also be noted that, although ordinal numbers (such as first and second) are used in the following description, they are used only to distinguish similar components, the order of which is not limited, and description of former components also applies to the latter. In addition, the use of the term “deformation” herein generally refers to bending, rolling, or folding, but is not limited thereto.

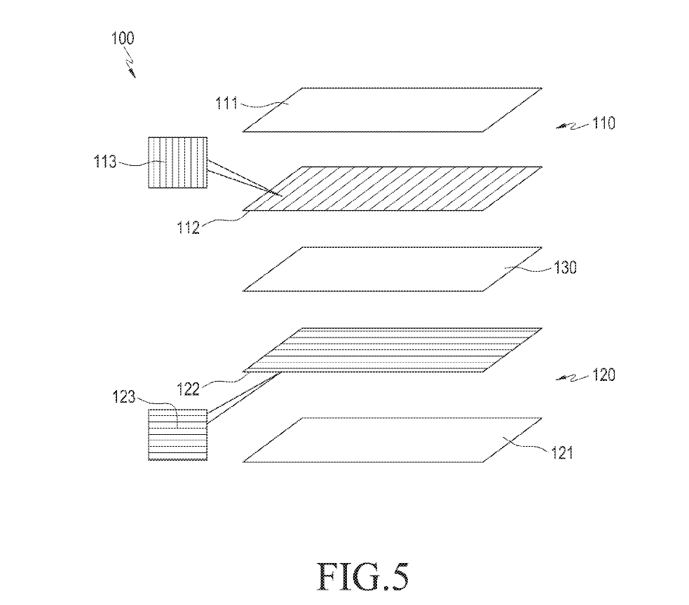

FIG. 5 illustrates a schematic structure of a pressure-sensing type touch panel according to an embodiment of the present invention. Referring to FIG. 5, the pressure-sensing type touch panel 100 is bonded to the rear surface of a flexible display (not shown), and has a plurality of sheets laminated to have a one-sheet structure. Specifically, the pressure-sensing type touch panel has a pressure-sensing layer 130 adapted to change in response to pressure and positioned at the center, and sheets having conductive layers 112, 122 and electrode layers 113, 123 are laminated (lamination refers to a type of processing to overlap and bond at least two films of the same type or different types) to both surfaces of the pressure-sensing layer 130, respectively, to provide a one-sheet structure. In particular, the pressure-sensing type touch panel 100 includes first and second layers 110 and 120 symmetrically positioned to each other and a pressure-sensing layer 130 positioned between the first and second layers 110 and 120 and adapted to change its resistance in response to pressure caused by touch of an object.

The touch panel 100 of this structure is obtained by arranging the first layer 110, the pressure-sensing layer 130, and the second layer 120 successively and laminating them. As a result, even if the flexible touch panel 100 is deformed, parts of the first and second layers 110 and 120, which face each other, are not dislocated. That is, even if the touch panel 100 undergoes deformation, the first layer 110, the pressure-sensing layer 130, and the second layer 120 remain laminated to one another.

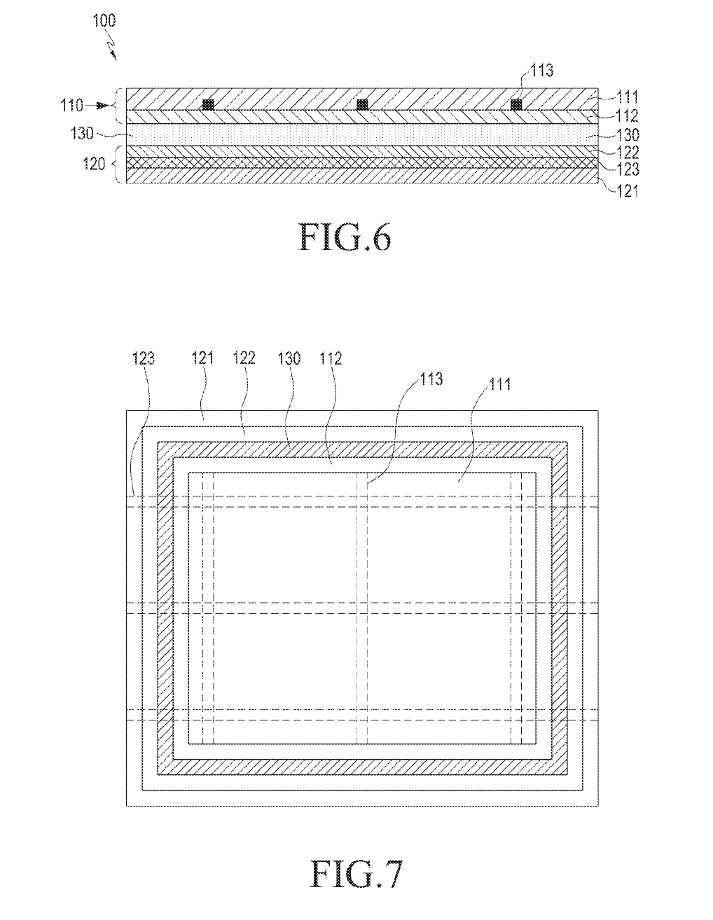

FIG. 6 illustrates the pressure-sensing type touch panel shown in FIG. 5 after lamination. FIG. 7 is a schematic top view of the pressure-sensing type touch panel shown in FIG. 6, and illustrates components at different sizes laminated on one another, ranging from the first substrate panel 111 to the second substrate panel 121. Referring to FIGS. 6 and 7, the first and second layers 110 and 120 are formed to be symmetrically positioned to each other with the pressure-sensing layer 130 at the center.

Specifically, the first layer 110 includes a first conductive layer 112, a first electrode layer 113, and a first substrate panel 111, which are arranged on a surface, i.e, an upper surface of the pressure-sensing layer 130 in this order. The first substrate panel 111 is positioned on the outermost part of the touch panel 100. The first conductive layer 112 is positioned between the first substrate panel 111 and the pressure-sensing layer 130 and is directly laminated onto the upper surface of the pressure-sensing layer 130. The first electrode layer 113 is arranged between the first substrate panel 111 and the first conductive layer 112 and is positioned on the first conductive layer 112 in a direction (vertical direction in this embodiment). The first layer 110, which consists of a plurality of sheets, is laminated onto a surface of the pressure-sensing layer 130, specifically the upper surface thereof, in the order of the first conductive layer 112 on the bottom, the first electrode layer 113 in the middle, and the first substrate panel 111 at the top of the first layer 110.

The second layer 120 includes a second electrode layer 123, a second conductive layer 122, and a second substrate panel 121, which are arranged on a lower surface of the pressure-sensing layer 130 in this order. The second substrate panel 121 is positioned on the outermost part of the touch panel 100. The second conductive layer 122 is positioned between the second substrate panel 121 and the pressure-sensing layer 130 and is directly laminated onto the lower surface of the pressure-sensing layer 130. The second electrode layer 123 is arranged between the second substrate panel 121 and the second conductive layer 122 and is positioned on the second conductive layer 122 in a direction, which intersects with the direction of formation of the first conductive layer 112 (horizontal direction in this embodiment). The second layer 120, which consists of a plurality of sheets, is laminated on the other surface of the pressure-sensing layer 130, specifically on the lower surface thereof, in the order of the second conductive layer 122, the second electrode layer 123, and the second substrate panel 121.

The conductive layers 112 and 122 or the electrode layers 113 and 123 of the first and second layers 110 and 120 can realize haptics, i.e. the user can feel a touch, such as through a voltage change. Specifically, capacitive coupling is formed between the conductive layers 112 and 122 or the electrode layers 113 and 123 and the object, such as the body (or finger). When the conductive layers 112 and 122 or the electrode layers 113 and 123 are driven by an electric input of a low frequency (such as 10-500 Hz), the finger's touch causes the capacitive coupling to generate vibration Coulomb force, which stimulates the finger surface and provides a haptic feel.

The first conductive layer 112, the first electrode layer 113, the second conductive layer 122, the second electrode layer 123, and the pressure-sensing layer 130 are preferably made of a transparent material having a high degree of optical transmittance, such as ITO (Indium Tin Oxide) film.

The pressure-sensing layer 130 includes a material, the linear resistance of which varies in response to pressure generated by touch of an object. For example, the pressure-sensing layer 130 according to the present embodiment preferably includes QTC (Quantum Tunneling Composite) material, which uses Ni (Nickel) particles as the conductive material, but the present invention is not limited thereto. For example, the pressure-sensing layer 130 is made of a material obtained by mixing a base material (usually a high-molecular material such as rubber) with conductive particles at a suitable ratio. When the pressure-sensing layer 130 is subjected to force or pressure, the resulting contraction of material reduces the particle interval and allows electric current to flow. Examples of such material include conductive rubber, which uses carbon black as conductive particles, and FSR (Force Sensing Resistor).

The pressure-sensing type touch panel 100 is obtained by laminating the second substrate panel 121, which serves as the bottom surface, the second electrode layer 123, the second conductive layer 122, the pressure-sensing layer 130, the first conductive layer 112, the first electrode layer 113, and the first substrate panel 111, in this order. Those skilled in the art can understand that, although two types of methods for manufacturing a pressure-sensing type touch panel 100 according to the present embodiment will now be described, the present invention is not limited to such methods, and various modifications are possible as long as the first layer 110, the pressure-sensing layer 130, and the second layer 120 are fastened to one another to form a single sheet. In a method for manufacturing a pressure-sensing type touch panel 100 according to the present embodiment, the second substrate panel 121 is used as the bottom surface, and, on the second substrate panel 121, the second electrode layer 123, the second conductive layer 122, the pressure-sensing layer 130, the first conductive layer 112, the first electrode layer 113, and the first substrate panel 111 are successively printed and laminated.

In another method for manufacturing a pressure-sensing type touch panel 100, the second electrode layer 123 and the second conductive layer 122 are bonded to the second substrate panel 121 to obtain the second layer 120; the first electrode layer 113 and the first conductive layer 112 are bonded to the first substrate panel 111 to obtain the first layer 110; the pressure-sensing layer 130 is arranged between the fabricated first and second layers 110 and 120, specifically between the first and second conductive layers 112 and 122; and the components are subjected to high temperature and high pressure to laminate them.

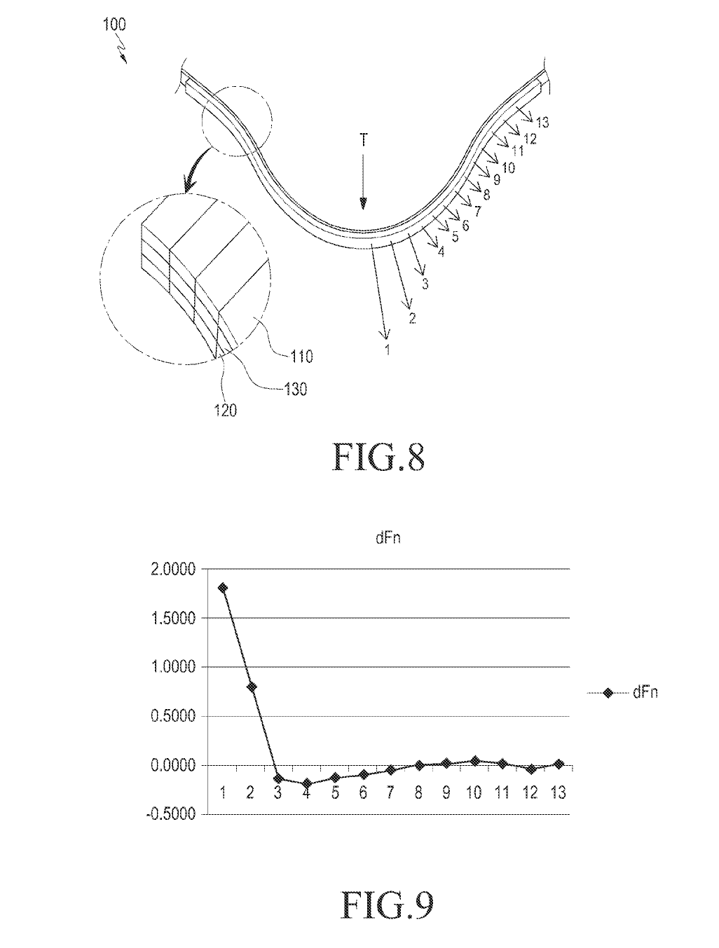

FIG. 8 illustrates local deformation of the pressure-sensing type touch panel shown in FIG. 6, and FIG. 9 illustrates a pressure value when a pressure is applied to a local portion on a laminate structure of the touch panel which is locally deformed in FIG. 8.

Referring to FIGS. 8 and 9, in the local deformation of the pressure-sensing type touch panel 100 of the above-mentioned stacked and laminated structure, the first layer 110, the pressure-sensing layer 130, and the second layer 120, which have been laminated, deform in the manner of a single sheet. This limits any change of thickness between the first and second layers 110 and 120 or dislocation of the first or second layer 110 or 120. That is, the pressure-sensing type touch panel 100 maintains the stacked structure either before or after bending. Particularly, referring to FIGS. 8 and 9, it can be noted that the pressures are changed at a local portion 1 and a local portion 2 near the location 1 where the touches are inputted in the touch panel staying in the bent state, and there are no pressure change at remaining local portions 3 thru 13. That is, the touch panel of the embodiment of the present invention is made in a form of one sheet without air gaps or liquid gaps, so as to definitely recognize the transmission of the pressure in a bent or folded state. As a result, it is possible for the touch panel to transmit the pressure more stably. Therefore, the touch panel 100 can accurately sense a touch at any location where pressure is applied, regardless of any deformation.

As described above, the pressure-sensing type touch panel according to the present invention has a pressure-sensing layer closely stacked between the first and second layers so that any change of distance between the first and second layers or their dislocation is prevented even if deformation occurs locally.

This ensures that the first and second layers can maintain a constant gap, regardless of flexible deformation, and the touch of an object can be sensed stably at any location.

While the present invention has been shown and described with reference to certain embodiments and drawings thereof, it will be understood by those skilled in the art that various changes in form and details may be made therein without departing from the spirit and scope of the invention as defined by the appended claims.

What is claimed is:

1. A pressure-sensing type touch panel comprising a plurality of sheets laminated to each other and forming a one-sheet structure, the touch panel being bonded to a rear surface of a flexible display.

2. The pressure-sensing type touch panel as claimed in 1, wherein the touch panel comprises:
first and second layers symmetrically positioned to each other; and
a pressure-sensing layer arranged between the first and second layers and adapted to change resistance in response to pressure caused by touch of an object, and
the first layer, the pressure-sensing layer, and the second layer are laminated so that, when a deformation occurs to the touch panel, the first layer, the pressure-sensing layer, and the second layer remain laminated.

3. The pressure-sensing type touch panel as claimed in 2, wherein the first layer comprises:
a first substrate panel;
a first conductive layer arranged between the first substrate panel and the pressure-sensing layer; and
a first electrode layer formed on the first conductive layer, wherein the first layer is laminated on an upper surface of the pressure-sensing layer in an order of the first conductive layer at a bottom, the first electrode layer at a middle, and the first substrate panel at a top of the first layer.

4. The pressure-sensing type touch panel as claimed in 3, wherein the second layer comprises:
a second substrate panel;
a second conductive layer arranged between the second substrate panel and the pressure-sensing layer; and
a second electrode layer provided below the second conductive layer in an opposite direction to the first electrode layer so as to intersect with the first electrode layer, wherein the second layer is laminated on a lower surface of the pressure-sensing layer in an order of the second conductive layer at a bottom, the second electrode layer at a middle, and the second substrate panel at a top of the second layer.

5. The pressure-sensing type touch panel as claimed in 4, wherein the touch panel is obtained by printing and laminating, on the second substrate panel, the second electrode layer, the second conductive layer, the pressure-sensing layer, the first conductive layer, the first electrode layer, and the first substrate panel successively from bottom to top of the touch panel.

6. The pressure-sensing type touch panel as claimed in 4, wherein the touch panel is obtained by bonding the first electrode layer and the first conductive layer to the first substrate panel to form the first layer, bonding the second electrode layer and the second conductive layer to the second substrate panel to form the second layer, arranging the pressure-sensing layer between the first and second layers, and applying pressure and heat and obtaining lamination.

7. The pressure-sensing type touch panel as claimed in 4, wherein the first and second conductive layers, the first and second electrode layers, and the pressure-sensing layer are made of a transparent material having high optical transmittance.

8. The pressure-sensing type touch panel as claimed in 2, wherein the pressure-sensing layer comprises a material having linear resistance varying in response to pressure generated by touch of an object.

9. The pressure-sensing type touch panel as claimed in 8, wherein the pressure-sensing layer comprises a QTC (Quantum Tunneling Composite) material.

10. A pressure-sensing type touch panel comprising:
a pressure-sensing layer having upper and lower surfaces and adapted to change in response to pressure; and
a plurality of sheets having conductive layers and electrode layers, respectively, the sheets being laminated to the upper and lower surfaces of the pressure-sensing layer and having a one-sheet structure,
wherein the conductive layers and the electrode layers are adapted to change, in response to touch of an object, and to cause realization of a haptic feel.

11. The pressure-sensing type touch panel as claimed in 10, wherein the conductive layers, the electrode layers, and the pressure-sensing layer are formed against each other.

12. The pressure-sensing type touch panel as claimed in 10, wherein the electrode layer, the conductive layer, the pressure-sensing layer, the conductive layer, the electrode layer, and an upper substrate are successively stacked on a lower substrate.

13. The pressure-sensing type touch panel as claimed in 10, wherein the electrode layer and the conductive layer are stacked on a lower substrate, the electrode layer and the conductive layer are stacked on an upper substrate, the pressure-sensing layer is arranged between the conductive layer of the lower substrate and the conductive layer of the upper substrate, and pressure and heat are applied and cause lamination.
